(19) United States
(12) Patent Application Publication
(10) Pub. No.: US 2023/0404845 A1
(43) Pub. Date: Dec. 21, 2023

(54) FOAM STICK

(71) Applicant: SUN OWN INDUSTRIAL CO., LTD., Changhua County (TW)

(72) Inventors: TIEN-SZU HSU, Changhua County (TW); SHU-JIN CHEN, Changhua County (TW); YI-PING CHUNG, Changhua County (TW); JIA-RUI XU, Changhua County (TW); GENG-LIN LIU, Changhua County (TW); CHUNG-LUN CHAN, Changhua County (TW)

(21) Appl. No.: 17/842,795

(22) Filed: Jun. 17, 2022

(51) Int. Cl. A61H 15/00

(52) U.S. Cl. CPC A61H 15/00; A61H 2015/0014; B63B 34/50; A61H 2201/169; A61H 2201/1261

(57) ABSTRACT

A foam stick includes a tube body, a core, and two covers. The tube body has an accommodating groove with two open ends. The core is disposed in the accommodating groove of the tube body. The two covers are disposed at both ends of the tube body to close the accommodating groove. The foam stick is composed of the tube body, the core and the covers, so the material utilization rate is high. Through the combination of the tube body, the core and the covers, the foam stick has different characteristics and can be used as rollers or floats.

### FIELD OF THE INVENTION

The present invention relates to a stick, and more particularly to a foam stick.

### BACKGROUND OF THE INVENTION

A conventional foam stick is used for sports purposes, such as a float stick or a yoga stick. The float stick is used for the user to hold, grasp or rest with both hands, so as to provide buoyancy to float on the water surface. The yoga stick is used for part of the user's body to rest thereon for yoga, balance exercise or rehabilitation.

The conventional foam stick is made of a single material, with a fixed hardness and softness. It may be too soft or too hard, and it cannot have the advantages of comfort and support. The method for manufacturing the conventional foam is to cut a plurality of sheet-shaped elastomer plates into a plurality of strip-shaped elastomers. Then, length cutting and chamfering cutting are carried out. Finally, they are placed in thermoforming equipment for shaping. The material utilization rate of the conventional foam stick is about 50%. The rest are waste materials that need additional processing after cutting, so the cost is higher. Accordingly, the inventor of the present invention has devoted himself based on his many years of practical experiences to solve these problems.

### SUMMARY OF THE INVENTION

The primary object of the present invention is to provide a foam stick, which has the advantages of different characteristics and high material utilization rate.

In order to achieve the above object, a foam stick comprises a tube body, a core, and two covers. The tube body has an accommodating groove with two open ends. The core is disposed in the accommodating groove of the tube body. The two covers are disposed at both ends of the tube body to close the accommodating groove.

The foam stick provided by the present invention is composed of the tube body, the core and the covers, so the material utilization rate is high. Through the combination of the tube body, the core and the covers, the foam stick has different characteristics and can be used as rollers or floats.

### BRIEF DESCRIPTION OF THE DRAWINGS

FIG. 1 is a perspective view in accordance with a first embodiment of the present invention;

FIG. 2 is an exploded view in accordance with the first embodiment of the present invention;

FIG. 3 is a schematic view in accordance with the first embodiment of the present invention when in use;

FIG. 4 is a perspective view in accordance with a second embodiment of the present invention;

FIG. 5 is a schematic view in accordance with a third embodiment of the present invention when in use;

FIG. 6 is a schematic view in accordance with a fourth embodiment of the present invention when in use; and

FIG. 7 is a cross-sectional view in accordance with a fifth embodiment of the present invention.

### DETAILED DESCRIPTION OF THE PREFERRED EMBODIMENTS

Embodiments of the present invention will now be described, by way of example only, with reference to the accompanying drawings.

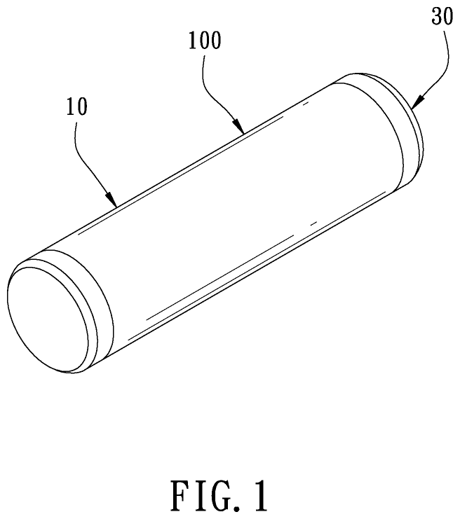

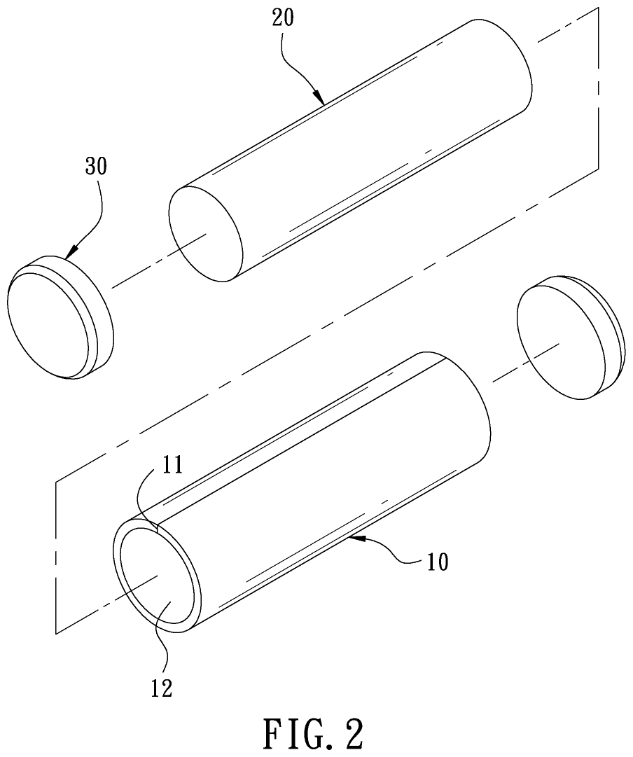

FIG. 1 is a perspective view in accordance with a first embodiment of the present invention. FIG. 2 is an exploded view in accordance with the first embodiment of the present invention. The present invention discloses a foam stick 100, comprising a tube body 10, a core 20, and two covers 30.

The cross-sectional shape of the tube body 10 may be circular, semicircular, rectangular or polygonal. The tube body 10 is made by first curling a sheet-shaped foamed elastomer and then joining its joint surfaces 11 on both sides. The tube body 10 has an accommodating groove 12 with two open ends. The outer peripheral wall of the tube body 10 may have at least one pattern, a plurality of protrusions or a combination thereof. The material of the tube body 10 is selected from one of polyethylene (PE), ethylene-vinyl acetate (EVA) copolymer and thermoplastic elastomer (TPE) or a combination thereof. The foamed elastomer may be selected from rigid foamed elastomer or soft foamed elastomer. The Shore C hardness of the rigid foamed elastomer is between 20 and 30. The Shore C hardness of the soft foamed elastomer is between 5 and 15.

The core 20 is disposed in the accommodating groove 12 of the tube body 10. The core 20 is selected from one of a production surplus material and a recycled waste material or a combination thereof. The material of the core 20 is selected from one of polyethylene (PE), ethylene-vinyl acetate (EVA) copolymer and thermoplastic elastomer (TPE) or a combination thereof. The core 20 may be one of a powdered filling material, a granular filling material, a block-shaped filling material, a parallel-arranged strip filling material, a coiled sheet filling material and a rolled filling material or a combination thereof. The parallel-arranged strip filling material, the coiled sheet filling material or the rolled filling material may be hard filling materials or soft filling materials according to hardness. The powdered filling material, granular filling material or block-shaped filling material may be a soft filling material. The powdered filling material, the granular filling material or the block-shaped filling material can be heated and melted to increase density.

The cross-sectional shape of the cover 30 corresponds to the cross-sectional shape of the tube body 10, which may be a circle, a semicircle, a rectangle or a polygon. The covers 30 are disposed at both ends of the tube body 10 to close the accommodating groove 12. The material of the cover 30 is selected from one of polyethylene (PE), ethylene-vinyl acetate (EVA) copolymer and thermoplastic elastomer (TPE) or a combination thereof. In this embodiment, the materials of the covers 30 and the tube body 10 are the same material.

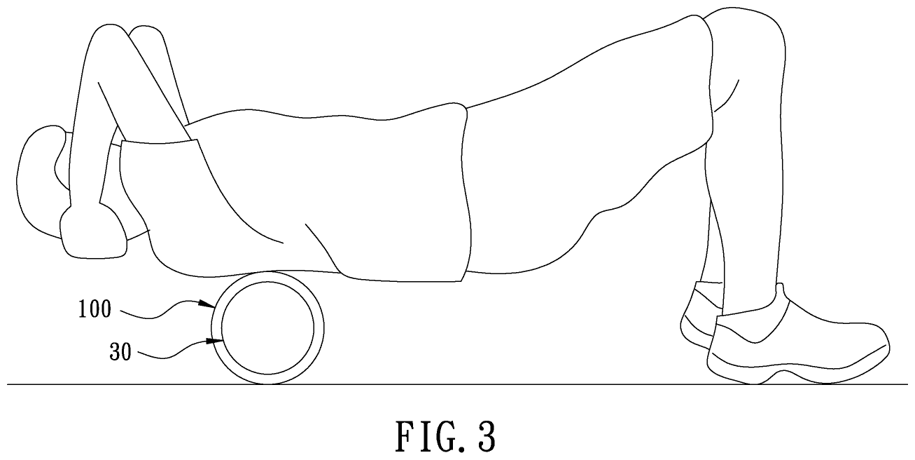

Please refer to FIG. 3. The tube body 10 and the covers 30 are made of soft foamed elastomers, and the core 20 is made of a hard filling material. Thus, the outside of the foam stick 100 is soft and the inside of the foam stick 100 is hard. The soft outside provides a comfort effect, and the hard inside provides a support effect. The foam stick provided by the present invention has comfort and support effects in use, and can be used as a training stick for yoga, balance exercise or rehabilitation.

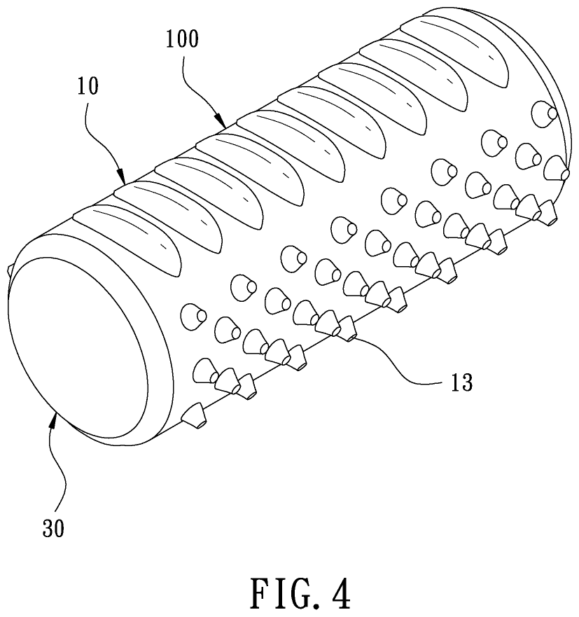

For manufacturing the foam stick 100, first, the sheet-like foamed elastomer is curled, and then both sides of the foamed elastomer are hot-melted or glued to form the tube body 10 having the accommodating groove 12 therein. Then, the core 20 is placed into the accommodating groove 12. The covers 30 are disposed at both ends of the tube body 10 respectively, so as to close the accommodating groove 12. Finally, the tube body 10, the core 20 and the covers 30 are placed in a thermoforming device, such as a mold, for the tube body 10, the core 20 and the covers 30 to be integrated into one, so that the foam stick 100 has a predetermined shape to complete the foam stick 100. Therefore, the production steps of the present invention are few. The tube body 10 is made of sheet-like foamed elastomer by curling. The core 20 is made of a surplus material or waste material, having the advantage of high material utilization rate. In cooperation with the materials of the tube body 10, the core 20 and the covers 30 as well as the different foams of the core 201, the foam stick 100 has different characteristics, and can be applied to products such as rollers or floats, etc. The foam stick 100 may be integrally formed with a pattern or protrusions 13 on the outer peripheral wall of the tube body 10. The protrusions 13 are shown in FIG. 4, so as to improve the appearance, anti-slip or functionality of the foam stick 100.

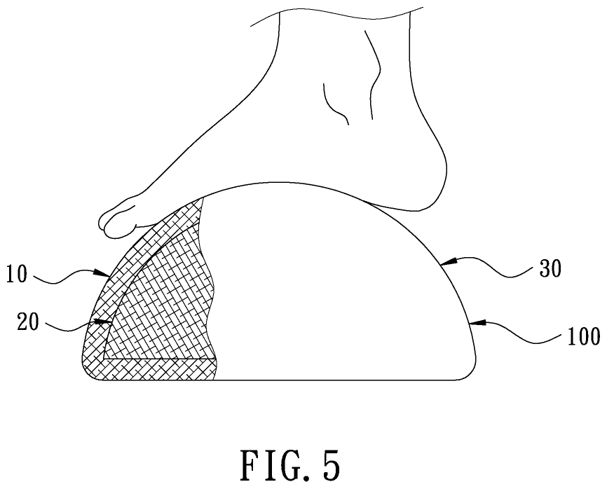

Please refer to FIG. 5. The foam stick 100 may have a semicircular cross-section. The tube body 10 and the covers 30 are made of soft foamed elastomers, and the core 20 is made of a hard filling material. Thus, the outside of the foam stick 100 is soft and the inside of the foam stick 100 is hard. The foam stick provided by the present invention has comfort and support effects in use, and can be used as a training stick for yoga, balance exercise or rehabilitation.

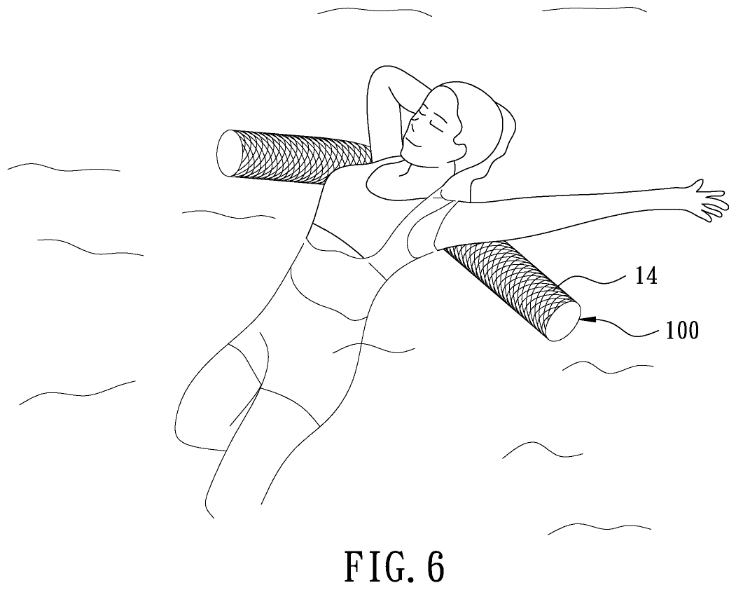

Please refer to FIG. 6. When the foam stick 100 is used in water as a float stick, the outer peripheral wall of the foam stick 100 is integrally formed with a pattern 14. The tube body 10 and the covers 30 are made of soft foamed elastomers, and the core 20 is made of a soft filling material. Thereby, the foam stick 100 has the characteristics of being hollow and soft, and can be used as an auxiliary device for floating in water.

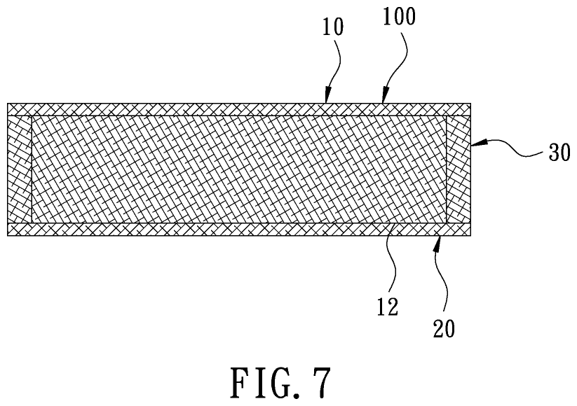

Please refer to FIG. 7. The fifth embodiment of the present invention is different from the first embodiment in that the covers 30 are disposed in the accommodating groove 12 and located at both open ends of the accommodating groove 12. The outer peripheral wall of the foam stick 100 is formed by the tube body 100, which can improve the structure and avoid the separation of the tube body 10 and the covers 30 to cause the core 20 to be exposed. When manufacturing the foam stick 100, one of the covers 30 is installed first, and then the core 20 is filled in the tube body 10, so as to simplify the manufacturing process.

What is claimed is:

1. A foam stick, comprising:
a tube body, having an accommodating groove with two open ends;
a core, disposed in the accommodating groove of the tube body;
two covers, being disposed at both ends of the tube body to close the accommodating groove.

2. The foam stick as claimed in claim 1, wherein the tube body and the covers each have a circular, semicircular, rectangular or polygonal cross-section.

3. The foam stick as claimed in claim 1, wherein the covers are disposed in the accommodating groove and located at both ends of the accommodating groove.

4. The foam stick as claimed in claim 1, wherein an outer peripheral wall of the tube body has at least one pattern.

5. The foam stick as claimed in claim 1, wherein an outer peripheral wall of the tube body has a plurality of protrusions.

6. The foam stick as claimed in claim 1, wherein the tube body is made of a material selected from one of polyethylene, ethylene-vinyl acetate copolymer and thermoplastic elastomer or a combination thereof.

7. The foam stick as claimed in claim 1, wherein the core is selected from one of a production surplus material and a recycled waste material or a combination thereof.

8. The foam stick as claimed in claim 1, wherein the core is made of a material selected from one of polyethylene, ethylene-vinyl acetate copolymer and thermoplastic elastomer or a combination thereof.

9. The foam stick as claimed in claim 1, wherein the core is one of a powdered filling material, a granular filling material, a block-shaped filling material, a parallel-arranged strip filling material, a coiled sheet filling material and a rolled filling material or a combination thereof.

10. The foam stick as claimed in claim 1, wherein the covers are made of a material selected from one of polyethylene, ethylene-vinyl acetate copolymer and thermoplastic elastomer or a combination thereof.
